(19) United States
(12) Patent Application Publication
(10) Pub. No.: US 2026/0342152 A1
(43) Pub. Date: Oct. 29, 2026

(54) ROTOR

(71) Applicant: Delta Electronics, Inc., Taoyuan City (TW)

(72) Inventors: Jian-Lin Huang, Taoyuan City (TW); Kun-Chou Lee, Taoyuan City (TW)

(21) Appl. No.: 19/457,078

(22) Filed: Jan. 22, 2026

(30) Foreign Application Priority Data
Apr. 24, 2025 (CN) 202520790369.0

(51) Int. Cl. H02K 1/27; H02K 7/00

(52) U.S. Cl. CPC H02K 1/27; H02K 7/003

(57) ABSTRACT

A rotor adapted to a motor includes a shaft having an axis and a main body. The main body is made of a mixture of plastic and magnetic powder and formed as a monolithic piece. The main body includes a first surface, a second surface, a plurality of ribs and a plurality of through holes. The first surface is perpendicular to the axis. The second surface is perpendicular to the axis, wherein the second surface and the first surface are configured to face opposite directions. The plurality of ribs are protrudently disposed on the first surface and/or the second surface and symmetrically surrounding the axis. The plurality of through holes are disposed in the main body, penetrating between the first surface and the second surface, and symmetrically surrounding the axis.

### CROSS-REFERENCE TO RELATED APPLICATIONS

This non-provisional application claims priority to China Patent Application No. 202520790369.0 filed on Apr. 24, 2025. The entire contents of application are incorporated herein by reference for all purposes.

### FIELD OF THE INVENTION

The present disclosure relates to a rotor, and more particularly to a rotor made of a mixture of plastic and magnetic powder and having improved heat dissipation effect.

### BACKGROUND OF THE INVENTION

Generally, rotors applied in the motors, such as inner rotors, are formed by using the plastic material to fix magnets onto the shaft. It needs to position the magnets in advance and then uses the plastic material to combine the magnets with the shaft. The manufacturing procedure is complicated with numerous steps.

Moreover, during the operation of the motor, both the rotor itself and other components inside the motor, such as circuit components, silicon steels, copper wires, etc., will generate heats, and how to effectively dissipate the heat and thus improve the performance of the motor has been an important issue in the field for a long time.

Therefore, there is a need of providing a rotor capable improving the drawbacks above.

### SUMMARY OF THE INVENTION

An object of the present disclosure is to provide a rotor which has simplified manufacturing procedure and improved heat dissipation efficiency.

In accordance with an aspect of the present disclosure, a rotor adapted to a motor is provided. The rotor includes a shaft having an axis and a main body. The main body is made of a mixture of plastic and magnetic powder and formed as a monolithic piece. The main body includes a first surface, a second surface, a plurality of ribs and a plurality of through holes. The first surface is perpendicular to the axis. The second surface is perpendicular to the axis, wherein the second surface and the first surface are configured to face opposite directions. The plurality of ribs are protrudently disposed on the first surface and/or the second surface and symmetrically surrounding the axis. The plurality of through holes are disposed in the main body, penetrating between the first surface and the second surface, and symmetrically surrounding the axis.

In an embodiment, the plurality of ribs are arranged along radical directions of the axis.

In an embodiment, the plurality of ribs comprise a first portion of ribs and a second portion of ribs, the first portion of ribs are protrudently disposed on the first surface, and the second portion of ribs are protrudently disposed on the second surface.

In an embodiment, projections of the first portion of ribs on a plane perpendicular to the axis are at least partially overlapped with projections of the second portion of ribs on the plane.

In an embodiment, projections of the first portion of ribs on a plane perpendicular to the axis are not overlapped with projections of the second portion of ribs on the plane.

In an embodiment, the main body further comprises a third surface connecting respective outer edges of the first surface and the second surface and parallel to the axis.

In an embodiment, a maximum distance between each of the plurality of ribs and the axis is less than a distance between the third surface and the axis.

In an embodiment, a distance between a longitudinal axis of each of the plurality of through holes and the axis is less than a distance between the longitudinal axis of each of the plurality of through holes and the third surface.

In an embodiment, the main body further comprises at least one groove formed within the main body and arranged to surround the shaft, and the at least one groove is configured to form from the first surface in a direction toward the second surface and/or from the second surface in a direction toward the first surface.

In an embodiment, a distance between an inner edge of the at least one groove and a periphery of the shaft is greater than zero.

In an embodiment, the plurality of through holes are corresponding to the at least one groove in a direction of the axis.

In an embodiment, the first surface comprises a first inner annular surface and a first outer annular surface, and the at least one groove is formed between the first inner annular surface and the first outer annular surface, and/or the second surface comprises a second inner annular surface and a second outer annular surface, and the at least one groove is formed between the second inner annular surface and the second outer annular surface.

In an embodiment, the plurality of ribs are protrudently disposed on the first outer annular surface and/or the second outer annular surface.

In an embodiment, at least one of the plurality of through holes is disposed between two adjacent ribs of the plurality of ribs.

In an embodiment, two sides of each of the plurality of ribs are configured to have different magnetic polarities.

The rotor of the present disclosure adapts the mixture of plastic and magnetic powder to prepare the main body thereof, so that the manufacturing procedure can be significantly simplified to one single step of injection molding, thereby effectively reducing the manufacturing complexity. Also, the main body has ribs protruded thereon which are capable of disturbing the surrounding air when the rotor is rotating, and through holes penetrating therein which help to generate circular airflows penetrating the main body during the rotation of the rotor, and both are beneficial of improving heat dissipation efficiency and thus the performance of the rotor.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1A is a schematic view showing a rotor according to an embodiment of the present disclosure;

FIG. 1B is a schematic view showing the rotor according to the embodiment of the present disclosure from another view angle;

FIG. 2A is a lateral view showing the rotor according to the embodiment of the present disclosure;

FIG. 2B is a top view showing the rotor according to the embodiment of the present disclosure;

FIG. 2C is a bottom view showing the rotor according to the embodiment of the present disclosure;

FIG. 3 is a schematic view showing a shaft of the rotor according to the embodiment of the present disclosure;

FIG. 4A is a sectional view of A-A’ plane in FIG. 2B;

FIG. 4B is a sectional view of B-B’ plane in FIG. 2B;

FIG. 5A is a top view showing a rotor according to another embodiment of the present disclosure;

FIG. 5B is a bottom view showing the rotor according to another embodiment of the present disclosure;

FIG. 6 is a schematic view showing a rotor according to another embodiment of the present disclosure;

FIGS. 7A-7D are schematic views showing examples of ribs of the rotor of the present disclosure; and

FIGS. 8A-8B are schematic views showing exemplary arrangements of magnetic poles of the rotor of the present disclosure.

### DETAILED DESCRIPTION OF EMBODIMENTS

The present disclosure will now be described more specifically with reference to the following embodiments. It is to be noted that the following descriptions of embodiments of this disclosure are presented herein for purpose of illustration and description only. It is not intended to be exhaustive or to be limited to the precise form disclosed.

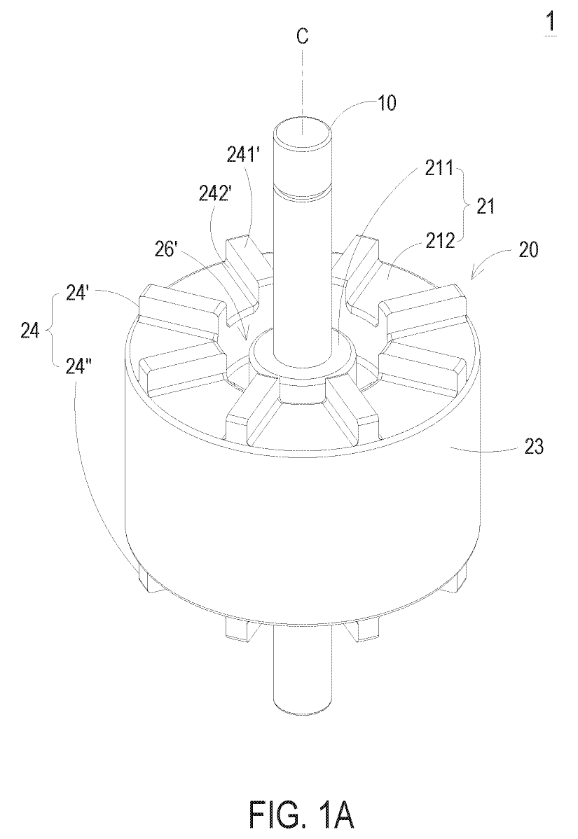

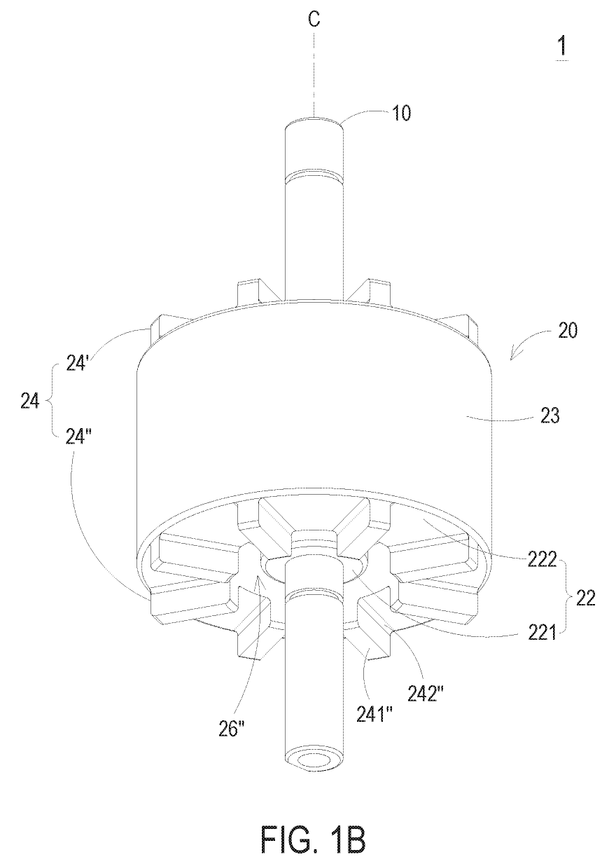

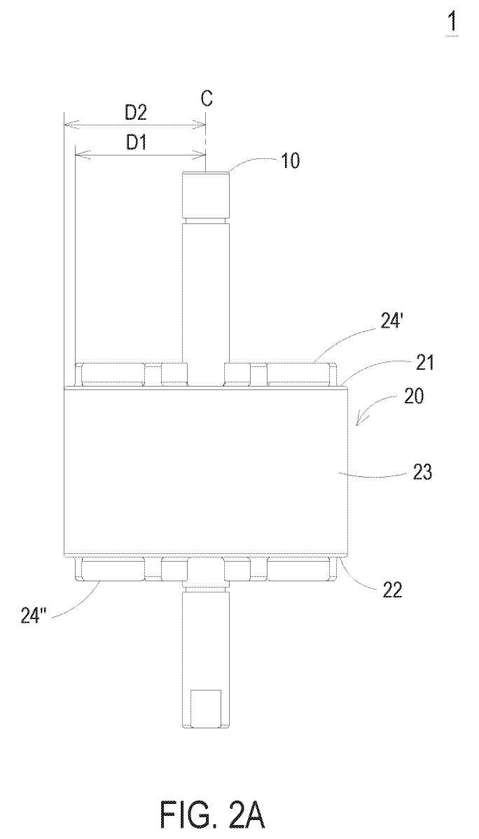

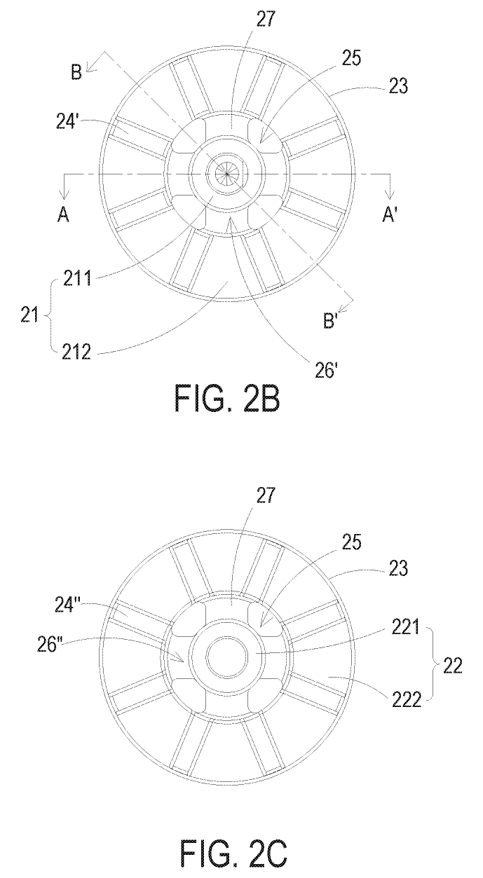

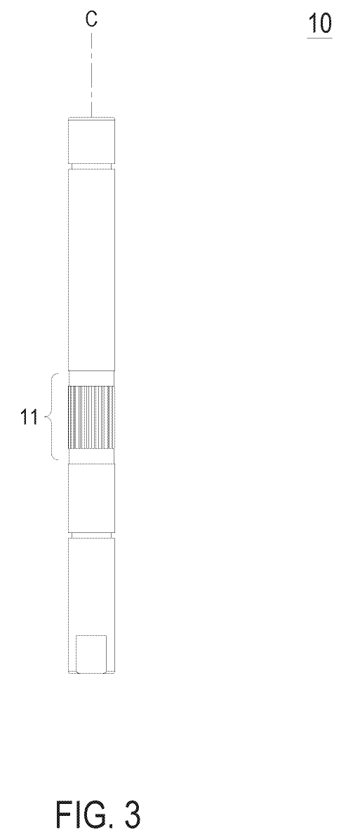

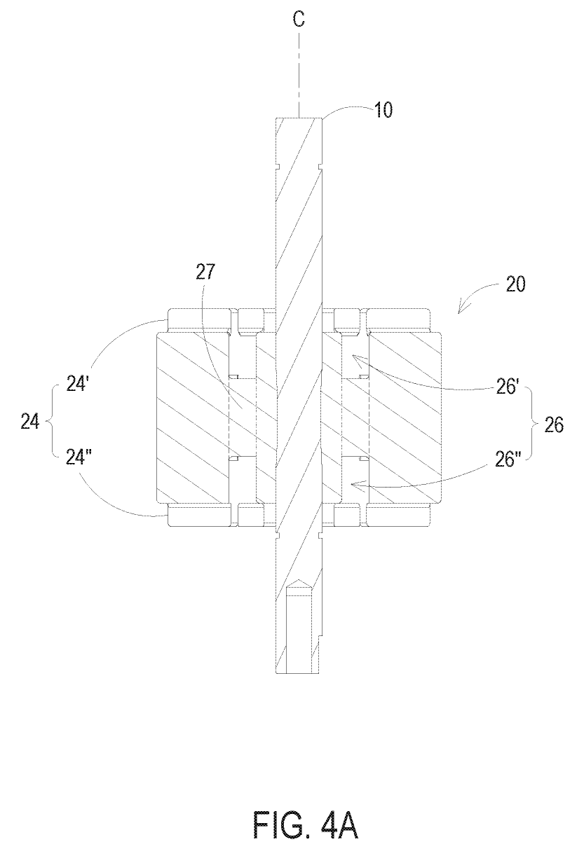

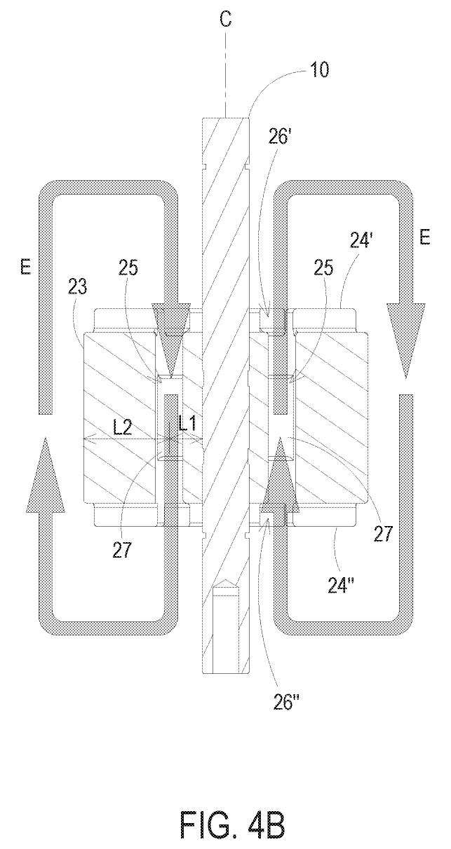

Refer to FIGS. 1A-1B, 2A-2C, 3 and 4A-4B. FIG. 1A is a schematic view showing a rotor according to an embodiment of the present disclosure, FIG. 1B is a schematic view showing the rotor according to the embodiment of the present disclosure from another view angle, FIGS. 2A-2C are respectively a lateral view, a top view and a bottom showing the rotor according to the embodiment of the present disclosure, FIG. 3 is a schematic view showing a shaft of the rotor according to the embodiment of the present disclosure, FIG. 4A is a sectional view of A-A’ plane in FIGS. 2B and 4B is a sectional view of B-B’ plane in FIG. 2B. A rotor 1 in the present disclosure is applied to a motor, such as an inner rotor motor, and matches with a stator in the motor to achieve the operation of the motor. The rotor 1 includes a shaft 10 and a main body 20. The shaft 10 has an axis C, and the main body 20 is configured to surround the shaft 10. Particularly, in the present disclosure, the main body 20 is a monolithic piece made of a mixture of plastic and magnetic powder, that is, the rotor 1 of the present disclosure includes only two members, one is the shaft and the other is the main body 20.

Compared with the manufacturing procedure in the prior art where the magnets are positioned first and then combined to the shaft through the plastic material, the main body 20 in the present disclosure employs the mixture of plastic and magnetic powder which simultaneously provides magnetic and adhering forces, so that only one single step of injection molding is needed for, at the same time, combining the main body 20 to the shaft 10 and arranging magnetic material around the shaft 10, which significantly simplifies the manufacturing procedure. Moreover, since the step of positioning the magnets is omitted and the formation and positioning of the main body 20 can be completed by employing one single mold, it can more precisely define the position relationship between every portion of the main body 20 and the shaft 10. In addition, as shown in FIGS. 3 and 4A, the shaft 10 has an ups-and-downs section 11, such as, steps or embossing, at a position corresponding to where the main body 20 is positioned, so that the combination force between the main body 20 and the shaft 10 can be further increased.

The main body 20 is approximately formed as an annular body surrounding the shaft 10. The main body 20 includes a central passage, a first surface 21, a second surface 22, a third surface 23, a plurality of ribs 24 and a plurality of through holes 25. The central passage is for accommodating the shaft 10. The first surface 21 and the second surface 22 are parallel to each other and perpendicular to the axis C. In other words, the first surface 21 and the second surface 22 are two planes facing opposite directions, as shown in FIG. 2A, where the first surface 21 faces upward and the second surface 22 faces downward. The third surface 23 connects respective outer edges of the first surface 21 and the second surface 22 and is parallel to the axis C. Thus, the third surface 23 is a curved surface surrounding the shaft 10, and the first surface 21, the second surface 22 and the third surface 23 collectively define the major portion of the main body 20. Moreover, the plurality of ribs 24 are disposed on the first surface 21 and/or the second surface 22, are arranged to symmetrically surround the axis C, and protrude toward a direction respectively away from the first surface 21 or the second surface 22. Furthermore, the plurality of through holes 25 are disposed inside the main body 20 and penetrating between the first surface 21 and the second surface 22, so that the plurality of through holes 25 form a plurality of openings respectively on the first surface 21 and the second surface 22. The plurality of through holes 25 are arranged as being parallel to and surrounding the axis C, for example, in a symmetric manner.

Based on that the plurality of ribs 24 are protruded structures on the first surface 21 and/or the second surface 22, when the rotor 1 is rotating, the air around the rotor 1 can be driven by the ups-and-downs structures formed by the ribs 24 to cause disturbed airflow, thereby achieving the heat dissipation effect, which is especially beneficial of dissipating heats from components around the rotor 1, for example, circuit components, silicon steels, copper wires, etc. On the other hand, the plurality of through holes 25 are passages penetrating between the first surface 21 and the second surface 22, namely, the air can flow inside the main body 20, so that when the rotor 1 is rotating, as shown in FIG. 4B, circular airflows E can be continuously generated within the through holes 25, which also helps to improve the heat dissipation efficiency. More specifically, in the present disclosure, through cooperation of the ribs 24 and the through holes 25, not only disturbed airflow around the rotor 1 can be produced to dissipate heats from components around the rotor 1, but also airflows inside the rotor 1 can be formed for further assisting in heat dissipation, and thus, both the heat dissipation efficiency and operation performance of the rotor 1 can be significantly improved.

Since the rotor 1 is integrally formed through the injection molding procedure, after the rotor 1 is formed, the ribs 24 can be used to adjust the balance, for example, through adjusting the number and/or volume of the protruded ribs 24. The positions of the plurality of through holes 25 inside the main body 20 are configured to close to the shaft 10, namely, the distance L1 between a longitudinal axis of each of the plurality of through holes 25 and the shaft 10 is less than the distance L2 between the longitudinal axis of each of the plurality of through holes 25 and the third surface 23. For example, in an embodiment, the distance L1 is less than half of the distance L2 to ensure that the volume of the main body 20 at the other sides of the through holes 25 relative to the shaft 10 is sufficient to provide the magnetic properties required for the operation of the motor. Furthermore, as configuring the through holes 25, it is also necessary to consider that the mechanical connection strength provided by the connecting portions 27 between adjacent through holes 25 must be sufficient to maintain the operation of the motor. More specifically, under the premise of achieving a balance between practical heat dissipation requirements and required mechanical strength, the numbers, cross-sectional areas, and distributions of the through holes 25 and the connecting portions 27 all can be varied. Besides, the through holes 25 are also beneficial of saving material and thus reducing cost.

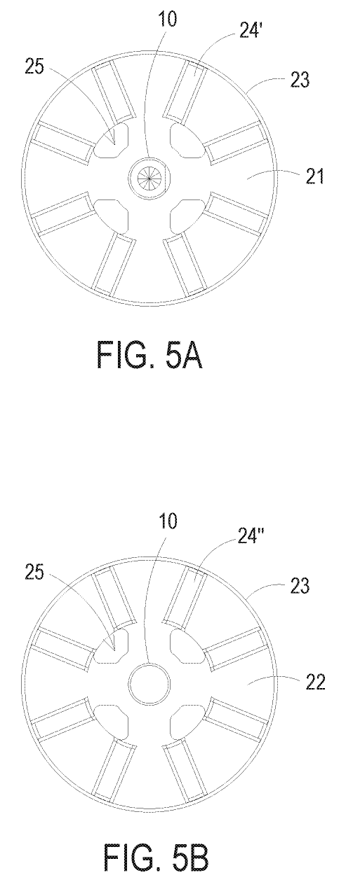

The main body 20 further includes at least one groove 26 concavely formed in the main body 20 from the first surface 21 and/or the second surface 22. Other than saving material and reducing cost, this design also facilitates the heat dissipation since groove(s) 26 also can form ups-and-downs structure(s) on the first surface 21 and/or the second surface 22 so as to cause disturbed airflows together with the ribs 24. The at least one groove 26 is configured to surround the shaft 10, and the distance between an inner edge thereof and a periphery of the shaft 10 is greater than zero. This design can maximize the combining surface between the main body 20 and the shaft 10, thereby helping to save materials while maintaining the combining force between the main body 20 and the shaft 10. In an embodiment, the at least one groove 26 includes a groove 26’ and a groove 26”, wherein the groove 26’ is formed within the main body 20 from the first surface 21 in a direction toward the second surface 22, and the groove 26” is formed within the main body 20 from the second surface 22 in a direction toward the first surface 21. Provision of the groove 26’ divides the first surface 21 into a first inner annular surface 211 and a first outer annular surface 212, and provision of the groove 26” divides the second surface 22 into a second inner annular surface 221 and a second outer annular surface 222. In this embodiment, positions of the grooves 26’, 26” are exactly corresponding to positions of the plurality of through holes 25, namely, the plurality of through holes 25 are corresponding to the grooves 26’, 26” in the direction of the axis C, and the plurality of through holes 25 are located between the first inner annular surface 211 and the first outer annular surface 212 and/or between the second inner annular surface 221 and the second outer annular surface 222. In other embodiments, positions of the grooves 26’, 26” also can be staggered with or partially overlapped with positions of the plurality of through holes 25, and can be varied in accordance with practical requirements. On the other hand, in other embodiments, the main body 20 also can be formed without groove, only with the groove 26’ at the first surface 21, or only with the groove 26” at the second surface 22. When no groove is formed, as shown in FIGS. 5A and 5B, the first surface 21 and the second surface 22 are respective single annular surfaces extended from the periphery of the shaft 10 to the third surface 23, and the plurality of through holes 25 form a plurality of openings on the first surface 21 and the second surface 22. Therefore, it can be selected to dispose or not dispose the groove and to change position of the groove in accordance with practical requirements.

The ribs 24 are disposed on the first surface 21 and/or the second surface 22 and within the space enclosed by the upward and downward extensions of the third surface 23. That is, the maximum distance D1 between each rib 24 and the axis C (which equals to the distance between the distal end of each rib 24 relative to the shaft 10 and the axis C) is less than or equal to the distance D2 between the third surface 23 of the main body 20 and the axis C. Within this space, under the premise of maintaining the balance of the rotor 1, the ribs 24 can be implemented in various forms and arranged in various ways in accordance with practical requirements.

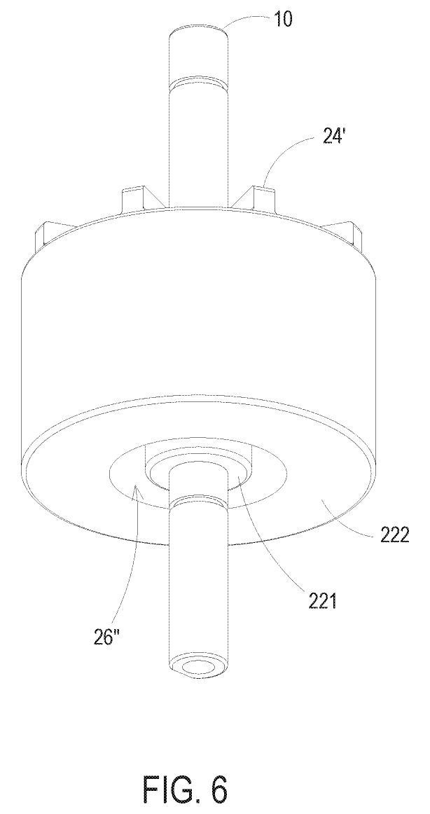

Based on the positions, the plurality of ribs 24 are further divided into a first portion of ribs 24’ which are protruded on the first surface 21, and a second portion of ribs 24” which are protruded on the second surface 22. The first portion of ribs 24’ are arranged on the first surface 21 to surround the axis C in a symmetrical manner, and the second portion of ribs 24” are arranged on the second surface 22 to surround the axis C in a symmetrical manner. The first portion of ribs 24’ are extended toward a direction away from the first surface 21, and the second portion of ribs 24” are extended toward a direction away from the second surface 22. That is, the first portion of ribs 24’ and the second portion of ribs 24” are extended toward opposite directions, as shown in FIG. 2A where the first portion of ribs 24’ are upward extended from the first surface 21, and the second portion of ribs 24” are downward extended from the second surface 22. In other embodiments, it also can be selected to provide the first portion of ribs 24’ only or the second portion of ribs 24” only. For example, as shown in FIG. 6, only the first surface 21 has the first portion of ribs 24’ disposed thereon; or alternatively, only the second surface 22 has the second portion of ribs 24” disposed thereon.

When both the first portion of ribs 24’ and the second portion of ribs 24” are provided, the arrangements thereof can be identical or different. That is, projections of the first portion of ribs 24’ on a plane perpendicular to the axis C and projections of the second portion of ribs 24” on the same plane can be overlapped with each other, partially overlapped or not overlapped. Under the premise of maintaining the balance of the rotor 1, the variations can be made.

Position relationship between the plurality of ribs 24 and the plurality of through holes 25 also can be varied. For example, in an embodiment, as shown in FIGS. 2B, 2C, 5A and 5B, the through holes 25 are configured to correspond to positions between adjacent ribs 24’ and between adjacent ribs 24”. In another embodiment, the through holes 25 are configured to correspond to positions of the ribs 24’ and/or ribs 24”. In another embodiment, different through holes 25 can be respectively implemented to have different position relationship with the ribs 24’, 24”, for example, can respectively correspond to a position between adjacent ribs, correspond to one of the ribs or not particularly correspond to the ribs. In addition, since the arrangement of the first portion of ribs 24’ on the first surface 21 might be different from the arrangement of the second portion of ribs 24” on the second surface 22, the position relationships of the through holes 25 with the ribs 24’ on the first surface 21 and with the ribs 24” on the second surface 22 also can be different.

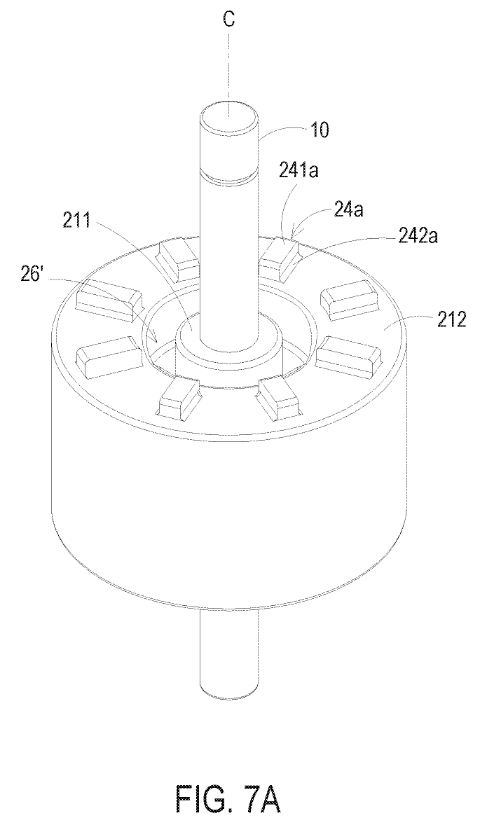

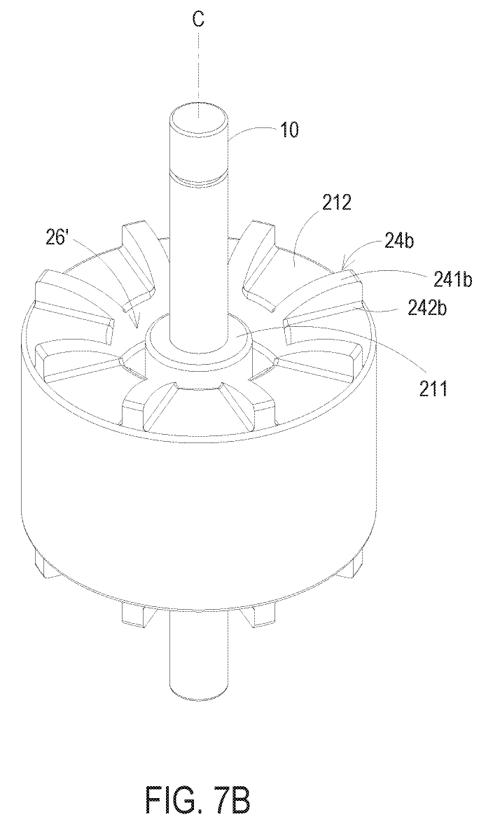

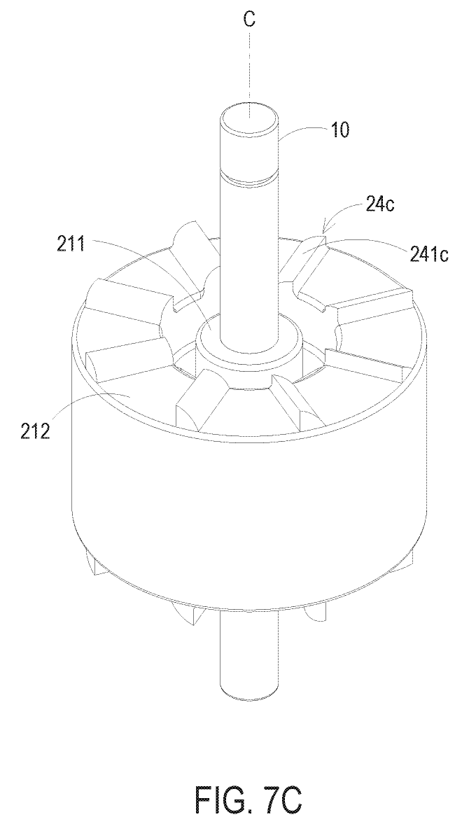

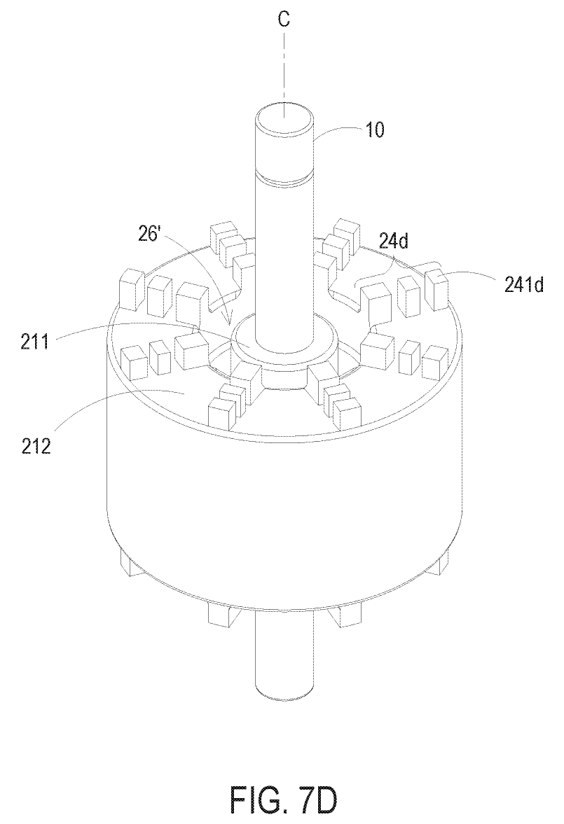

Each of the plurality of ribs 24 can be implemented to be different. For example, in an embodiment, as shown in FIGS. 1A and 1B, ribs 24’, 24” are implemented as three-dimensional rectangular structures arranged along radial directions of the shaft 10, top surfaces 241’, 241” are approximately parallel to the first outer annular surface 212/the second outer annular surface 222 and connected with the first outer annular surface 212/the second outer annular surface 222 through arc connecting surfaces 242’, 242”, and ribs 24’, 24” are approximately extended from the inner edge to the outer edge of the first outer annular surface 212/the second outer annular surface 222. In another embodiment, as shown in FIG. 7A, ribs 24a are implemented as three-dimensional rectangular structures arranged along radial directions of the shaft 10, top surfaces 241a are approximately parallel to the first outer annular surface 212 and connected with the first outer annular surface 212 through arc connecting surfaces 242a, and there are gaps between the ribs 24a and the inner edge and between the ribs 24a and the outer edge of the first outer annular surface 212.

In another embodiment, as shown in FIG. 7B, ribs 24b are implemented as three-dimensional arc structures arranged along radial directions of the shaft 10 with the heights thereof are gradually increased from the inner edge of the first outer annular surface 212 to the outer edge, namely, top surfaces 241b are not parallel to the first outer annular surface 212, and top surfaces 241b are connected with the first outer annular surface 212 through arc connecting surfaces 242b. In another embodiment, as shown in FIG. 7C, ribs 24c are implemented as quarter cylindrical structures arranged along radial directions of the shaft 10, top surfaces 241c are approximately parallel to the first outer annular surface 212, and ribs 24c are approximately extended from the inner edges to the outer edges of the first outer annular surface 212. Alternatively, ribs 24c also can be implemented as semi-cylindrical structures or other structures formed by splitting a cylinder along a longitudinal plane thereof. In another embodiment, as shown in FIG. 7D, ribs 24d are arranged along radial directions of the shaft 10, and each of the ribs 24d is implemented to include plural three-dimensional rectangular structures, namely, there are multiple spaced sub-ribs arranged in each radial direction, and the length of each sub-rib along the radial direction may be identical or different. Top surfaces 241d are approximately parallel to the first outer annular surface 212.

Therefore, the arrangements of ribs 24, 24a, 24b, 24c, 24d on the first surface 21/the second surface 22 can be varied, and there are no limitation on the shape, size and/or positions thereof. For example, top surface of each rib can be parallel or not parallel to the first surface 21/the second surface 22, and/or each rib can be one single member or consist of plural parts. Moreover, ribs on the first surface 21 can be identical or different from each other, and ribs on the second surface 22 also can be identical or different from each other, for example, the first surface 21 can simultaneously have different ribs as shown in FIGS. 1A and 7A disposed thereon. As long as the structures are protruded on the first surface 21 and/or the second surface 22 and are capable of causing disturbances of the surrounding air during the rotation of the rotor 1, it belongs to the scope of the present disclosure and can be varied in accordance with practical requirements.

Notably, although ribs 24, 24a, 24b, 24c, 24d shown in accompanying figures are arranged along the radial directions, under the premise of maintaining the balance of the rotor 1, the position and orientation of each rib 24 can be varied as needed.

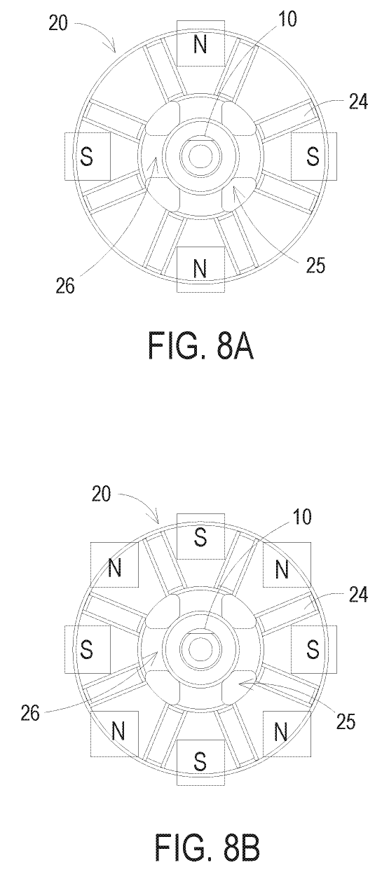

Since the main body 20 is made of one single material, namely the mixture of plastic and magnetic powder, and is formed through injection molding procedure, all portions, such as ribs 24 and connecting portions 27, of the main body 20 are made of the same material and thus are magnetic. After the main body 20 is formed, the rotor 1 can be simply prepared by utilizing the magnetizer to set the magnetic poles. There is no limit to the number of magnetic poles N and S. For example, the setting can be, as shown in FIG. 8A, two respective magnetic poles N and S, or as shown in FIG. 8B, four respective magnetic poles N and S. In an embodiment, the magnetic poles of the main body 20 can be further set such that two sides of each rib 24 have different magnetic polarities, for example, as shown in FIG. 8B, each magnetic pole is located between two adjacent ribs 24, or as shown in FIG. 8A where only two respective magnetic poles N and S are set, the magnetic polarities at two sides of each rib 24 are also different.

In conclusion, the rotor in the present disclosure is made of the mixture of plastic and magnetic powder, so that the rotor can be prepared by directly forming the main body around the shaft in one single step through the injection molding procedure, which significantly reduces the manufacturing complexity. Moreover, the rotor in the present disclosure further has ribs disposed on the surface of the main body and through holes formed inside the main body, which can cause disturbances of surrounding air when the rotor is rotating and generate circular airflows inside the rotor, thereby effectively improving the heat dissipation efficiency.

While the disclosure has been described in terms of what is presently considered to be the most practical embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A rotor, adapted to a motor, comprising:
a shaft having an axis; and
a main body made of a mixture of plastic and magnetic powder, wherein the main body is formed as a monolithic piece, the main body comprising:
a first surface perpendicular to the axis;
a second surface perpendicular to the axis, wherein the second surface and the first surface are configured to face opposite directions;
a plurality of ribs protrudently disposed on the first surface and/or the second surface and symmetrically surrounding the axis; and
a plurality of through holes disposed in the main body, penetrating between the first surface and the second surface, and symmetrically surrounding the axis.

2. The rotor as claimed in claim 1, wherein the plurality of ribs are arranged along radical directions of the axis.

3. The rotor as claimed in claim 1, wherein the plurality of ribs comprise a first portion of ribs and a second portion of ribs, the first portion of ribs are protrudently disposed on the first surface, and the second portion of ribs are protrudently disposed on the second surface.

4. The rotor as claimed in claim 3, wherein projections of the first portion of ribs on a plane perpendicular to the axis are at least partially overlapped with projections of the second portion of ribs on the plane.

5. The rotor as claimed in claim 3, wherein projections of the first portion of ribs on a plane perpendicular to the axis are not overlapped with projections of the second portion of ribs on the plane.

6. The rotor as claimed in claim 1, wherein the main body further comprises a third surface connecting respective outer edges of the first surface and the second surface and parallel to the axis.

7. The rotor as claimed in claim 6, wherein a maximum distance between each of the plurality of ribs and the axis is less than a distance between the third surface and the axis.

8. The rotor as claimed in claim 6, wherein a distance between a longitudinal axis of each of the plurality of through holes and the axis is less than a distance between the longitudinal axis of each of the plurality of through holes and the third surface.

9. The rotor as claimed in claim 1, wherein the main body further comprises at least one groove formed within the main body and arranged to surround the shaft, and the at least one groove is configured to form from the first surface in a direction toward the second surface and/or from the second surface in a direction toward the first surface.

10. The rotor as claimed in claim 9, wherein a distance between an inner edge of the at least one groove and a periphery of the shaft is greater than zero.

11. The rotor as claimed in claim 9, wherein the plurality of through holes are corresponding to the at least one groove in a direction of the axis.

12. The rotor as claimed in claim 9, wherein the first surface comprises a first inner annular surface and a first outer annular surface, and the at least one groove is formed between the first inner annular surface and the first outer annular surface, and/or the second surface comprises a second inner annular surface and a second outer annular surface, and the at least one groove is formed between the second inner annular surface and the second outer annular surface.

13. The rotor as claimed in claim 12, wherein the plurality of ribs are protrudently disposed on the first outer annular surface and/or the second outer annular surface.

14. The rotor as claimed in claim 1, wherein at least one of the plurality of through holes is disposed between two adjacent ribs of the plurality of ribs.

15. The rotor as claimed in claim 1, wherein two sides of each of the plurality of ribs are configured to have different magnetic polarities.
